(19) United States
(12) Patent Application Publication
(10) Pub. No.: US 2025/0379298 A1
(43) Pub. Date: Dec. 11, 2025

(54) ELECTROCHEMICAL CELL HOUSING WITH BARRIER LAYER AND METHODS OF PRODUCING THE SAME

(71) Applicant: 24M Technologies, Inc., Cambridge, MA (US)

(72) Inventor: Ryan Michael LAWRENCE, Watertown, MA (US)

(21) Appl. No.: 19/221,010

(22) Filed: May 28, 2025

Related U.S. Application Data
(60) Provisional application No. 63/656,682, filed on Jun. 6, 2024.

(51) Int. Cl. H01M 50/129; H01M 50/119; H01M 50/141

(52) U.S. Cl. CPC H01M 50/129; H01M 50/119; H01M 50/141

(57) ABSTRACT

An assembly includes a housing defining an internal volume. An electrochemical cell is disposed in the internal volume. A barrier layer disposed on at least a portion of the housing, the barrier layer including a metal and configured to inhibit fluid communication between the inner volume of the housing and the external environment. The barrier layer may include a plurality of layers, at least one of the plurality of layers including the metal. The plurality of layers may include a first layer disposed on a surface of the housing, the first layer formed of a first material, and a second layer disposed on the first layer, the second layer formed from a second material including the metal.

### CROSS-REFERENCE TO RELATED APPLICATIONS

This application claims priority to and the benefit of U.S. Provisional Patent Application No. 63/656,682, filed Jun. 6, 2024, and titled, “Electrochemical Cell Housing with Barrier Layer and Methods of Producing the Same,” the disclosure of which is hereby incorporated herein by reference in its entirety.

### TECHNICAL FIELD

Embodiments described herein relate to systems, devices, and methods for inhibiting moisture ingress in electrochemical cell housings.

### BACKGROUND

Non-aqueous battery technologies such as lithium-ion electrochemical cells typically use a hermetically sealed case to inhibit the ingress of moisture or egress of electrolyte from the electrochemical cell, both of which negatively impact product performance and shorten product life. Typical electrochemical cell and battery casings are often formed of an impermeable metal, such as, for example, steel or aluminum. These materials come at a cost premium relative to plastic materials used, for example, in lead acid batteries, and because these materials are conductive, additional insulating materials generally have to be included in such assemblies to inhibit electrical shorts.

### SUMMARY

Embodiments described herein relate to assemblies including housings with one or more barrier layers and one or more electrochemical cells disposed therein. In particular, embodiments described here relate to an assembly including a housing defining an internal volume. An electrochemical cell may disposed in the internal volume. A barrier layer may be disposed on at least a portion of the housing, the barrier layer including a metal and configured to inhibit fluid communication between the inner volume of the housing and an external environment In some embodiments, the barrier layer may include a plurality of layers, at least one of the plurality of layers including the metal. The plurality of layers may include a first layer disposed on a surface of the housing, and a second layer disposed on the first layer. In some embodiments. the first layer may be formed of a first material, and the second layer may be formed from a second material including the metal.

In some embodiments, an assembly includes a housing defining an internal volume; an electrochemical cell disposed in the internal volume, and a barrier layer disposed on at least a portion of the housing, the barrier layer including a metal and configured to inhibit fluid communication between the inner volume of the housing and the external environment.

In some embodiments, an assembly includes a housing having an internal volume, the housing including a first polymer material; a cell stack disposed in the internal volume, the cell stack including a plurality of electrochemical cells; and a barrier layer assembly disposed on at least a portion of the housing, the barrier layer assembly including a first layer including a second polymer material, the first layer disposed on the housing; a second layer disposed on the first layer, the second layer including a metal material, and a third layer disposed on the second layer, the third layer including a third polymer material, the barrier layer assembly configured to inhibit fluid communication between the inner volume of the housing and a region outside the housing.

In some embodiments a method includes: disposing an electrochemical cell in an internal volume of a housing; and bonding a barrier layer to at least a portion of the housing, the barrier layer including at least a metal material and a polymer material disposed on the metal material such that the barrier layer is configured to inhibit fluid communication between the inner volume of the housing and a region external to the housing.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

FIG. 1A is a schematic block diagram of an assembly including an electrochemical cell disposed in a housing and a barrier layer coupled to at least a portion of the housing, according to an embodiment.

FIG. 1B is a schematic block diagram of an electrochemical cell, according to an embodiment.

FIGS. 2A-2B show an electrochemical cell stack disposed in an inner volume of a housing, according to an embodiment.

FIG. 3A shows a housing with a barrier layer disposed on an outer surface thereof, according to an embodiment.

FIG. 3B shows an exploded view of the housing and the barrier layer of FIG. 3A, according to an embodiment.

FIG. 3C shows a cross-section view of an interface between a surface of the housing and the barrier layer, according to an embodiment.

FIGS. 4A-4C show a barrier layer being wrapped around an outer surface of a housing on five sides of the housing, according to an embodiment.

FIGS. 5A-5B show a barrier layer being disposed on an inner surface of a housing on five sides of the housing, according to an embodiment.

FIG. 6 illustrates a barrier layer including a plurality of layers, according to an embodiment.

FIG. 7 illustrates the barrier layer of FIG. 6 bonded to a surface of a portion of a housing, according to an embodiment.

FIG. 8 illustrates a barrier layer including a plurality of layers, according to an embodiment.

FIG. 9A is an exploded view of an electrochemical cell stack disposed in a housing including one or more barrier layers coupled to the housing, according to an embodiment.

FIG. 9B shows the housing of FIG. 9A including a sealing material disposed along an edge of the housing, according to an embodiment.

FIG. 10 is a flow chart of a method for encasing an electrochemical cell in a housing with a barrier layer, according to an embodiment.

### DETAILED DESCRIPTION

Plastic casings are commonly used in lead-acid batteries and other batteries with aqueous electrolytes. Lead-acid battery applications are not moisture sensitive and are therefore not significantly impacted by the ingress and egress of moisture over the life of the product. Lithium-ion cells, however, are sensitive to moisture ingress and electrolyte egress, both of which can negatively impact battery performance and cycle life. Lithium-ion electrochemical cells are increasingly being packaged in a “pouch” format that can include a soft composite “laminate” material. This material can employ polymers (e.g., polyethylene terephthalate (PET), Nylon, polypropylene (PP), polyethylene (PE), etc.) in the outer layers for providing chemical resistance and heat-sealability, and a metal in the inner layer (e.g., aluminum, stainless steel, etc.) for its superior barrier properties. The main drawback with this approach is the limited size of the cell that can be built, owing to the limited draw depth of such laminates. In other implementations, metallized layers can be applied directly to a non-metallic battery case and molded in metal plates. Both of these methods have significant drawbacks. Direct metallization of battery cases may be expensive at low to moderate manufacturing scales, may create an unwanted conductive surface on either the inside or outside of the cell, and may limit the types of metal that can be used due to chemical compatibility concerns. Molded-in plates are expensive and may result in very thick case walls thus reducing volumetric and gravimetric energy densities.

In contrast, embodiments described herein include non-metallic housings for electrochemical cells or cell casings (e.g., plastic housings) which are low in cost (i.e., cheaper) relative to metallic housings and can be manufactured in a range of sizes-beyond the limitations of typical “pouch” cells. A substantially hermetic barrier may be achieved by bonding a metallized film to the inside or outside of the housing such that the metallized film covers a significant portion of the exposed area of the housing. By bonding metallized film to a significant portion of a plastic battery case, it may be made substantially hermetic and thus appropriate for lithium-ion applications.

Embodiments of the electrochemical cell housings including metallized films described herein may provide one or more benefits including, for example: (1) accommodating a larger cell size and/or number of cells that can be hermetically sealed; (2) improving volumetric and gravimetric energy densities compared to molded-in plate designs; (3) minimizing thickness of housing walls; (4) using simple processes to reduce manufacturing time; and (5) implementing easily accessible materials to achieve hermetic design at a low cost.

Embodiments described herein may include a housing (e.g., a molded plastic case) and one or more sheets of a barrier layer (e.g., a metallized polymer film with high barrier properties). The barrier layer may be bonded to the housing over a substantial proportion (e.g., more than 80%) of a surface area of the housing such that the barrier properties of the barrier layer inhibit the ingress or egress of various chemical species (e.g., water, electrolyte, oxygen gas, etc.) from the housing. The barrier layer may be disposed on (e.g., bonded to) the inside and/or outside of the housing. The barrier layer may be bonded to the housing via thermal bond (“heat seal”), pressure sensitive adhesive, over-molding, or any other suitable method. In some embodiments, an electrochemical cell housing or electrochemical cell stack housing may be formed from or include metal (e.g., steel or aluminum) via deep-drawing, extrusion, casting, or another suitable process. In such embodiments, a sealing material (e.g., a polymer sealing strip) may be applied to open edges of the housing and a metallized film may be thermally bonded to the sealing material, thereby creating a hermetically sealed housing that is lighter and thinner than a housing formed entirely from metal.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can include a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference herein.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

The term “substantially” when used in connection with the term “hermetic” to define the effect of a barrier layer is intended to convey that the barrier layer inhibits moisture ingress or egress from a surface on which the barrier layer is disposed by greater than about 95%.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

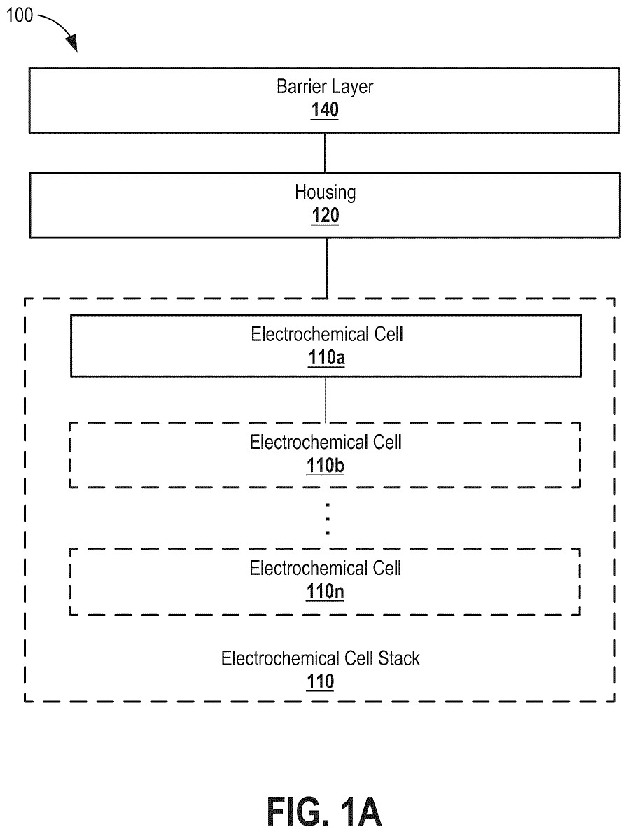

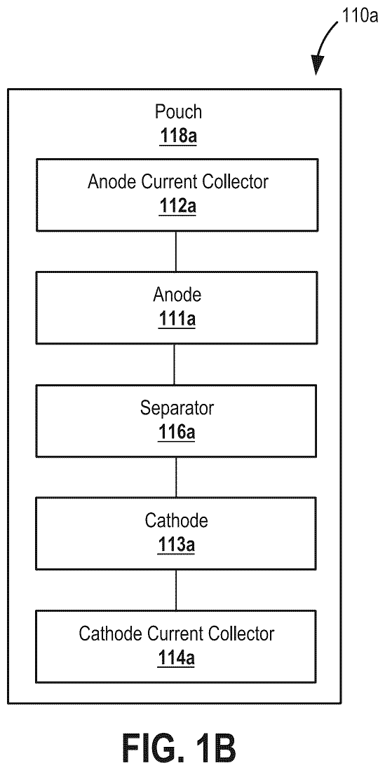

FIG. 1A is a schematic block diagram of an assembly 100 including one or more electrochemical cells 110a, 110b, . . . , 110n (collectively “110a-110n”) disposed in a housing 120, and a barrier layer 140 disposed on (e.g., coupled to) at least a portion of the housing 120, according to an embodiment. In some embodiments, the electrochemical cells 110a-110n may be arranged in an electrochemical cell stack 110 (hereinafter, “cell stack 110”, or “stack 110”) in which the electrochemical cells 110a-110n are stacked on top of one another. In some embodiments, the cell stack 110 may be disposed in the housing 120 such that a first outermost electrochemical cell 110n is disposed on or in contact with a first sidewall of the housing 120, and a second outermost electrochemical cell 110a is disposed proximate to or in contact with a second side wall of the housing 120 that is opposite the first sidewall.

The electrochemical cells 110a-110n may include any suitable electrochemical cell configured to store electrical energy and deliver electrical energy on demand. For example, FIG. 1B is a schematic block diagram of the electrochemical cell 110a that may be included in the assembly 100. In some embodiments, each of the electrochemical cells 110a-110n included in the stack 110 may be substantially similar to each other. While FIG. 1B shows a particular embodiment of the electrochemical cell 110a that may be included in the assembly 100, this is for illustrative purposes only and the stack 110 can include any other electrochemical cells having any suitable structure or formulation. All such embodiments are envisioned and should be considered to be within the scope of the present disclosure.

As shown, the electrochemical cell 110a includes an anode 111a disposed on an anode current collector 112a, a cathode 113a disposed on a cathode current collector 114a, and a separator 116a disposed between the anode 111a and the cathode 113a.

The anode 111a includes an anode active material. In some embodiments, the anode 111a can include an anode conductive material. In some embodiments, the anode 111a can include a semi-solid anode. The anode 111a is disposed on the anode current collector 112a and is configured to receive electrons therefrom. In some embodiments, the anode current collector 112a can include copper, aluminum, nickel, titanium, any other suitable metal, or any suitable combination thereof.

The cathode 113a includes a cathode active material. In some embodiments, the cathode 113a can include a cathode conductive material. In some embodiments, the cathode 113a can include a semi-solid cathode. The cathode 113a is disposed on the cathode current collector 114a and is configured to communicate electrons thereto. In some embodiments, the cathode current collector 114a can include aluminum, copper, or any other suitable current collector material.

The separator 116a can include any suitable separator that acts as an ion-permeable layer, for example, an ion-permeable membrane. In other words, the separator 116a allows exchange of ions while maintaining physical separation of the cathode 113a and the anode 111a. For example, the separator 116a can be any conventional membrane that is capable of ion transport. In some embodiments, the separator 116a is a liquid impermeable membrane that permits the transport of ions therethrough, namely a solid or gel ionic conductor. In some embodiments the separator 116a is a porous polymer membrane infused with a liquid electrolyte that allows for the shuttling of ions between the cathode 113a and anode 111a electroactive materials, while inhibiting the transfer of electrons.

In some embodiments, the separator 116a can be a microporous membrane that prevents particles forming the positive and negative electrode compositions from crossing the membrane. For example, the membrane materials can include or be selected from polyethylene oxide (PEO) polymer in which a lithium salt is complexed to provide lithium conductivity, or NAFION™ membranes which are proton conductors. For example, PEO based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. In some embodiments, the separator 116a can include polyethylene, polypropylene, polyimide, or any combination thereof. In some embodiments, the separator 116a can be made from a ceramic such as alumina. In some embodiments, the separator 116a can be made from a suitable polymer with ceramic particles dispersed within the separator 116a or deposited on one or both surfaces of the separator 116a.

In some embodiments, a first film can be coupled to the anode current collector 112a and a second film can be coupled to the cathode current collector 114a. The first film and the second film can be coupled together to form a pouch 118a. In some embodiments, the pouch can be composed of polyethylene, polypropylene, polystyrene, polyethylene terephthalate (PET), high density polyethylene (HDPE), low density polyethylene (LDPE), polyvinyl chloride (PVC), polyether ether ketone (PEEK), polybutylene terephthalate (PBT), polyvinylidene fluoride (PVDF), polycarbonate. or any combination thereof. In some embodiments, the pouch can be composed of polyethylene naphthalate (PEN), polysulfone, Nylon, polyphenylene sulfide (PPS), polyimide (PI), polyamide-imide (PAI), polytetrafluoroethylene (PTFE), or any combination thereof. In some embodiments, the pouch can include phenylethylammonium iodide (PEAI), liquid crystal polymer (LCP), epoxy, acrylic, polyoxymethylene (POM), sheet molding compound (SMC), or any combination thereof.

In some embodiments, the pouch 118a can block electrolyte liquid and vapor from escaping to the high voltage series connection points between electrochemical cells 110 in the system. This can prevent corrosion/oxidation. PET film can be effective at blocking the electrolyte fluid. In some embodiments, the films can block the electrolyte liquids and vapors from escaping the electrochemical cell 110a and corroding an integrated heater (not shown) in the system. Some polymers have appropriate molecular formulations to allow small gas molecules to escape during formation (e.g., H₂, H₂O CH₄, C₂H₂) but block effective solid-electrolyte interphase (SEI) formation gases (e.g., CO₂, SO₂, C₃H₄O₃, C₄H₆O₃, C₅H₁₀O₃) as well as electrolyte vapor to ensure good SEI protection during formation. For example, PET can have pores of a desired size to allow the passage of desired gases, but block the passage of undesired gases.

In some embodiments, the pouch 118a can have pores having an average pore diameter of at least about 0.2 nm, at least about 0.3 nm, at least about 0.4 nm, at least about 0.5 nm, at least about 0.6 nm, at least about 0.7 nm, at least about 0.8 nm, at least about 0.9 nm, at least about 1 nm, at least about 2 nm, at least about 3 nm, at least about 4 nm, at least about 5 nm, at least about 6 nm, at least about 7 nm, at least about 8 nm, or at least about 9 nm. In some embodiments, the pouch 118a can have pores having an average pore diameter of no more than about 10 nm, no more than about 9 nm, no more than about 8 nm, no more than about 7 nm, no more than about 6 nm, no more than about 5 nm, no more than about 4 nm, no more than about 3 nm, no more than about 2 nm, no more than about 1 nm, no more than about 0.9 nm, no more than about 0.8 nm, no more than about 0.7 nm, no more than about 0.6 nm, no more than about 0.5 nm, no more than about 0.4 nm, or no more than about 0.3 nm. Combinations of the above-referenced pore diameters are also possible (e.g., at least about 0.2 nm and no more than about 10 nm or at least about 0.5 nm and no more than about 5 nm), inclusive of all values and ranges therebetween. In some embodiments, the pouch 118a can have pores having an average pore diameter of about 0.2 nm, about 0.3 nm, about 0.4 nm, about 0.5 nm, about 0.6 nm, about 0.7 nm, about 0.8 nm, about 0.9 nm, about 1 nm, about 2 nm, about 3 nm, about 4 nm, about 5 nm, about 6 nm, about 7 nm, about 8 nm, about 9 nm, or about 10 nm.

In some embodiments, a coating can be disposed on the pouch to engineer and/or control the size of the pores of the pouch 118a. In some embodiments, the coating can include or be formed from a conductive material. In some embodiments, the coating can include or be formed from a non-conductive material. In some embodiments, the coating can include or be formed from a combination of conductive and non-conductive materials. In some embodiments, the coating can include Al₂O₃, SiO, SiO₂, MgO MgO₂, ZrO, ZrO₂, TiO, TiO₂, ZnO, ZnO with aluminum, Ta₂O₅, La₂O₃, Mn₃O₄, Nb₂O₅, InGaZnO₄, Pb(Zr, Ti)O₃, Ti₅O₁₂, TiC, SiC, indium tin oxide (ITO), sulfated tin oxide (STO), or any combination thereof. In some embodiments, the coating can include copper, nickel, aluminum, titanium, gold, niobium, chromium, molybdenum, tungsten, tantalum, or any alloy including a combination thereof. In some embodiments, the coating layer can be applied via sputtering, wet coating, dry coating, chemical vapor deposition, plasma-enhanced chemical vapor deposition, or any other suitable application method. In some embodiments, the coating can include a ceramic. In some embodiments, the coating can include boehmite.

In some embodiments, the coating can have a thickness of at least about 500 nm, at least about 1 μm, at least about 1.5 μm, at least about 2 μm, at least about 2.5 μm, at least about 3 μm, at least about 3.5 μm, at least about 4 μm, or at least about 4.5 μm. In some embodiments, the coating can have a thickness of no more than about 5 μm, no more than about 4.5 μm, no more than about 4 μm, no more than about 3.5 μm, no more than about 3 μm, no more than about 2.5 μm, no more than about 2 μm, no more than about 1.5 μm, or no more than about 1 μm. Combinations of the above-referenced thicknesses are also possible (e.g., at least about 500 nm and no more than about 5 μm or at least about 1 μm and no more than about 2 μm), inclusive of all values and ranges therebetween. In some embodiments, the coating can have a thickness of at least about 500 nm, at least about 1 μm, at least about 1.5 μm, at least about 2 μm, at least about 2.5 μm, at least about 3 μm, at least about 3.5 μm, at least about 4 μm, about 4.5 μm, or about 5μm.

In some embodiments, the pouch 118a of the electrochemical does not include metal. In other words, the pouch may include one or more layers formed from non-metallic materials. In some embodiments, the pouch can be excluded.

Referring again to FIG. 1A, in embodiments in which the assembly 100 includes more than one electrochemical cell, the electrochemical cells 110a-110n included in the stack 110 can be connected in parallel. In some embodiments, the electrochemical cells 110a-110n can be connected in series. In some embodiments, the plurality of electrochemical cells 110a-110n can be disposed in the stack 110 with anodes and anode current collectors on either terminal end of the stack (i.e., a parallel connection). In some embodiments, the electrochemical cells 110a-110n can be disposed in the stack 110 with cathodes and cathode current collectors on either terminal end of the stack (i.e., a parallel connection).

In some embodiments, instead of including a single stack 110, the assembly 100 may include a plurality of cell substacks that are disposed on top of each other, side by side, or in any suitable configuration or arrangement, and secured to each other to form the cell stack 110. For example, each of the substacks may be disposed in a substack housing, and the substack housings may be stacked on top of each other to form the cell stack 110. Any number of electrochemical cells may be included in a substack or the cell stack 110. In some embodiments, the cell stack 110 may include any number of substacks, for example, the cell stack 110 may include 1 substack to 100 substacks (e.g., 1, 2, 3, 4, 5, 6, 7, 8, 9, 10, 12, 14, 16, 18, 20, 25, 30, 35, 40, 45, 50, 55, 60, 65, 70, 75, 80, 85 90, 95, or 100 substacks), inclusive of all ranges and values therebetween. In some embodiments, a number of electrochemical cells in each substack may be in a range of 4 to 100 (e.g., 5, 10, 15, 20, 25, 30, 35, 40, 45, 50, 55, 60, 65, 70, 75, 80, 85, 90, 95, or 100 electrochemical cells), inclusive of all ranges and values therebetween. A plurality of substacks disposed in their respective substack housings (e.g., a container, a case, a carrier, or any other housing defining an internal volume within which a substack is disposed) can be stacked on top of one another to form the stack 110. In other words, in some embodiments, the housing 120 may include an inner volume (i.e., internal volume), and the cell stack 110 (or one or more of the electrochemical cells 110a-110n, or substacks) may be disposed in the inner volume of the housing 120.

The housing 120 can be formed from a strong and rigid material. In some embodiments, the housing 120 can be formed from an electrically non-conductive material, for example, a non-metallic material. In some embodiments, the housing 120 may include or be formed from plastic(s) and/or a polymer(s) including, but not limited to, polypropylene (PP), polyethylene terephthalate (PET), polyethylene (PE), Nylon, any other suitable material, or a combination thereof. Alternatively or additionally, the housing 120 may include metals including iron, aluminum, nickel, stainless steel, carbon steel, galvanized steel, alloys, any other suitable material, or a combination thereof. In some embodiments, the housing 120 may be formed via deep-drawing, extrusion, molding, casting, welding, or any other suitable process. The housing 120 may have any suitable shape, for example, square, rectangle, polygon, oval, circular, any other suitable shape or a combination thereof. In some embodiments, the housing 120 may define an opening at a face or side of the housing 120, for example, a top end of the housing 120. The stack 110 may be inserted through the opening into the internal volume defined by the housing 120. The opening may be closed using a cover (e.g., a cap, plate, etc.) once the stack 110 has been disposed in the internal volume. In some embodiments, the cover may be coupled to the housing 120 via welding, bonding, mechanical fasteners, adhesives, or any other technique to seal the opening. In some embodiments, the cover may include electrical connection points (e.g., terminals, knobs, detents, tabs, etc.) accessible from outside of the housing 120 such that the electrochemical cells 110a-110n inside the housing 120 may be electrically connected to external components. In some embodiments, a geometry of the cover may accommodate the structure of the cell stack(s) 110. For example, the cover may include a detent or one or more raised portions to accommodate the cell stack(s) 110 within the housing, for example, to facilitate alignment or securement of the cell stack(s) 110 in the housing 120.

In some embodiments, the cell stack 110 may include connectors including a positive connector (e.g., wire, busbar, cable, etc.) and a negative connector (e.g., wire, busbar, cable, etc.) configured to electrically couple or connect the electrochemical cells 110a-110n in the cell stack 110 to the one or more electrical connection points or terminals (e.g., knob, tab, etc.) on the housing 120. For example, the terminals may be disposed on an outer surface of a sidewall and/or a cover of the housing 120. The connectors may be configured so that multiple electrochemical cells 110a-110n (e.g., an anode current collector or a cathode current collector of each of the electrochemical cells 110a-110n) are electrically coupled to a corresponding one of the terminals, thereby allowing electrical energy to be communicated to and/or withdrawn from the one or multiple electrochemical cells 110a-110n via the terminals coupled thereto.

In some embodiments, the barrier layer 140 may be coupled to at least a portion of a surface of the housing 120 to prevent or inhibit fluid communication between the inner volume of the housing 120 and a region or environment external the housing 120. In some embodiments, the barrier layer 140 may include a plurality of layers. For example, the number of layers in the barrier layer 140 may be in a range of about 1 layer to about 10 layers, inclusive of all ranges and subranges therebetween. In some embodiments, the barrier layer 140 may include 1 layer, 2 layers, 3 layers, 4 layers, 5 layers, 6 layers, 7 layers, 8 layers, 9 layers, or 10 layers. In some embodiments, the barrier layer 140 may include 2 layers. In some embodiments, the barrier layer 140 may include 4 layers. In some embodiments, the barrier layer 140 may include 5 layers. In some embodiments, the layers may be coupled to one another via bonding (e.g., chemical and/or thermal), pressure joining, adhesion, fusion bending, etc. In some embodiments, each layer may have a thickness in a range of about 0.01 mm to about 10 mm, inclusive of all ranges and subranges therebetween. In some embodiments, the thickness of each layer may be no greater than 10 mm. In some embodiments, each layer of the barrier layer 140 may have the same thickness. In some embodiments, the layers may have each have a different thickness. In some embodiments, any subset of the layers may have the same thickness. In some embodiments, a total thickness of the barrier layer 140 may be in a range of about 0.01 mm to about 50 mm, inclusive of all ranges and subranges therebetween. In some embodiments, the total thickness of the barrier layer 140 may be no greater than 50 mm. In some embodiments, the total thickness of the barrier layer 140 may be about 20 mm. In some embodiments, the total thickness of the barrier layer 140 may be about 10 mm. In some embodiments, the total thickness of the barrier layer 140 may be about 5 mm. In some embodiments, the total thickness of the barrier layer 140 may be about 1 mm.

In some embodiments, the barrier layer 140 may include a first layer including a first material, and a second layer disposed on the first layer. The second layer may include a second material different from the first material. In some embodiments, the barrier layer 140 may include a first layer including a first material, a second layer disposed on the first layer and including a second material, a third layer disposed on the second layer and including a third material, and a fourth layer disposed on the third layer and including a fourth material. In some embodiments, two or more of the layers may include the same material. In some embodiments, each of the layers may include a different material. In some embodiments, the barrier layer 140 may include at least one metal layer, for example, a layer including a metal or metal material. In some embodiments, the barrier layer 140 may include at least one metal layer and at least one polymer layer. In some embodiments, the barrier layer 140 (e.g., any one or more of the layer(s) in the barrier layer 140) may be formed from a metallic material including, but not limited to, aluminum, steel, copper, lead, nickel, tin, titanium, any other suitable metal, or any suitable combination thereof. In some embodiments, the barrier layer 140 includes a metal layer may be formed from aluminum. The metal layer may prevent or inhibit fluid communication across one more walls of the housing 120.

In some embodiments, the barrier layer 140 may include a polymer layer. In some embodiments, the barrier layer 140 (e.g., any one or more layer(s) in the barrier layer 140 such as the polymer layer) may be formed from or include a material including, but not limited to, polyethylene (PE), polypropylene (PP), polystyrene, polyethylene terephthalate (PET), high density polyethylene (HDPE), low density polyethylene (LDPE), linear low density polyethylene (LLPDE), polyvinyl chloride (PVC), polyether ether ketone (PEEK), polybutylene terephthalate (PBT), polyvinylidene fluoride (PVDF), polycarbonate, or any combination thereof. In some embodiments, the polymer layer may be formed from or include polyethylene naphthalate (PEN), polysulfone, Nylon, polyphenylene sulfide (PPS), polyimide (PI), polyamide-imide (PAI), polytetrafluoroethylene (PTFE), or any combination thereof. In some embodiments, the polymer may be formed from or include a material including, but not limited to, PP, PET, Nylon, Linear low-density polyethylene (LLDPE) or any suitable combination thereof. In some embodiments, the housing 130 and/or the barrier layer 140 may include a corrosion or flame resistant material (e.g., TEFLON®, Nylon, aluminum oxide, titanium oxide, corrosion and/or flame resistance paint, etc.), any other suitable corrosion and/or flame-resistant materials, or a combination thereof.

In some embodiments, the barrier layer 140 may be a metallized polymer film with high barrier properties. In other words, the barrier layer 140 may resist a flow of moisture, gas, etc. between the inner volume of the housing 120 and the external environment.

In some embodiments, the plurality of layers (i.e., of the barrier layer 140) may be arranged in a predetermined order. For example, the first layer (e.g., inner layer configured to contact the housing 120) may be or may include a polymer layer, and a metal layer may be a subsequent layer disposed on an outer surface of the polymer layer, i.e., a surface distal from the surface of the housing 120 on which the barrier layer 140 is disposed. In some embodiments, the first layer of the barrier layer 140, i.e., the layer of the barrier layer 140 that is in direct contact with a corresponding surface of the housing 120 may include or be formed from the same material as the housing 120 and/or surface of the housing 120. For example, the housing 120 may be formed from polypropylene (PP), and the first layer of the barrier layer 140 may also be formed from PP. In such embodiments, the first layer of the barrier layer 140, and the surface of the housing 120 may be thermally bonded to one another. In some embodiments, the first layer of the barrier layer 140 may be coupled to the corresponding surface of the housing 120 via an adhesive.

In some embodiments, a first layer of the barrier layer 140 may include PP, a second layer of the barrier layer disposed on an outer surface of the first layer may include aluminum, a third layer disposed on an outer surface of the second layer may include nylon, and a fourth layer disposed on an outer surface of the third layer may include PET. Alternatively, the barrier layer 140 may include a first layer including low density polyethylene (LDPE), a second layer including PE, a third layer including aluminum, a fourth layer including PE, and a fifth layer including PET disposed on an outer surface of the fourth layer. Any of the barrier layer 140 configurations described herein incorporate easily accessible materials and are low cost to manufacture or obtain. In some embodiments, the plurality of layers may be formed from any suitable material and may be arranged in any suitable order to form the barrier layer 140. All such embodiments are envisioned and should be considered to be within the scope of the present disclosure.

In some embodiments, the barrier layer 140 may be disposed on the housing 120 over at least a portion of an inner and/or an outer surface of the housing 120. In some embodiments, the barrier layer 140 may be bonded to a surface of the housing 120. In some embodiments, at least a portion of the barrier layer 140 may be coupled to the housing via a thermal bond (“heat seal”), a chemical bond, a pressure sensitive adhesive, and/or overmolding. Because the barrier layer 140 is coupled (e.g., bonded) to the housing 120, the material(s) of the barrier layer 140 may have a low mechanical strength, enabling barrier layers that are simple to fabricate and have a relatively smaller thickness relative to non-bonded barrier layers. In some embodiments, the barrier layer 140 may be disposed on only a portion of a total surface (inner surface or outer surface) of the housing 120 to substantially inhibit fluid communication between the inner volume of the housing 120 and an environment external to the housing 120, for example, substantially hermetically seal the housing 120.

In some embodiments, the portion may be at least 30%, at least 40%, at least 50%, at least 60%, at least 70%, at least 80%, at least 90%, at least 95%, at least 99% of the surface (e.g., inner surface or outer surface) of the housing 120. In some embodiments, the portion may be no more than 100%, no more than 95%, no more than 90%, no more than 80%, no more than 70%, no more than 60%, or no more than 55%. In some embodiments, the portion may be at least about 80% of the total surface of the housing 120, i.e., the barrier layer 140 is disposed on at least about 80% of an inner surface or outer surface of the housing 120. In some embodiments, the portion may be at least about 85% of the total surface of housing 120, i.e., the barrier layer 140 is disposed on at least about 85% of an inner surface or outer surface of the housing 120.

In some embodiments, the barrier layer 140 may include plurality of portions configured to be disposed on respective sides or surfaces of the housing 120. In some embodiments, a shape of each portion of the barrier layer 140 may correspond to a shape or location of a surface of respective wall (e.g., inside surface and/or outside surface of the respective wall) or cover of the housing 120. For example, the barrier layer 140 may be formed into a plurality of rectangles and/or squares having dimensions corresponding to walls (inner and/or outer) of the housing 120. In some embodiments, the plurality of portions may be coupled to each other. In some embodiments, the plurality of portions may include physically separate portions shaped and sized to be disposed on specific surface of the walls of the housing 120. In some embodiments, the barrier layer 140 may be formed into at least six separate portions corresponding to each surface of the housing 120, i.e., four side faces, a top surface, and a bottom surface of the housing 120.

In some embodiments, each portion of the barrier layer 140 may be configured to cover an entirety of a respective wall of the housing 120. In some embodiments, edges and/or corners of the housing 120 may not be covered by the barrier layer 140. In some embodiments, the edges and/or corners of the housing 120 may be covered by the barrier layer 140. In some embodiments, the barrier layer 140 may be configured to wrap around the sides of the housing 120 such that each of the sides, edges, and/or corners of the housing 120 are covered. In some embodiments, a sealing material may be disposed on the edges and/or corners of the housing 120 and bonded to the barrier layer 140 to seal any openings in the barrier layer 140 at the edges and/or corners.

The plurality of portions of the barrier layer 140 may additionally or alternatively form one sheet, i.e., the plurality of portions of the barrier layer 140 may be coupled to each other. The barrier layer 140 may form a sheet (e.g., a contour wrap) configured to wrap around a plurality of walls of the housing 120. For example, the barrier layer 140 may be formed into a sheet having a central region or base portion, and four extensions or portions (e.g., a cross shape, “X” shape, “t” shape) extending outwards in different directions from the central region or base portion. The central region may be disposed on a bottom surface (e.g., a bottom inner or outer surface) of the housing 120, and each extension may be folded onto a respective sidewall (e.g., bottom inner or outer surface) of the housing 120. In some embodiments, a dimension of each extension may correspond to dimensions of a respective wall of the housing 120. In some embodiments, a first sheet may be configured to be disposed around (e.g., wrap around) at least a portion of an outer surface of the walls of the housing 120, and a second sheet may be configured to be disposed on (e.g., cover) at least a portion of an inner surface of the walls of the housing 120. In some embodiments, the sheet(s) of the barrier layer 140 may be disposed on (e.g., cover) up to 100% of a total surface of the housing 120, for example, disposed on faces as well as corners and edges of the walls of the housing 120.

In some embodiments, one or more sections of the housing 120 may be replaced entirely by the barrier layer 140. Expanding further, in some embodiments, the housing 120 may have openings defined in one or more open side walls (e.g., top and bottom sides) of the housing 120, or one or more sidewalls of the housing 120 may be excluded such that when cell stack 110 is disposed in the housing 120, corresponding side of the cell stack 110 are exposed to the external environment or otherwise, accessible from the external environment. In such embodiments, portions or sheets of barrier layer 140 may be disposed on the sides of the housing 120 as well as directly on the exposed sides or surfaces of the cell stack 110 to inhibit moisture ingress or egress from the sides of the cell stack 110 that are proximate to the open sides of the housing 120. In some embodiments, any sidewall of the housing 120 may be replaced with the barrier layer 140. In some embodiments, the housing 120 having two open sides may allow for easier and faster assembly and/or less material needed for the assembly. In some embodiments, the barrier layer 140 may be a metallized film as described herein. Using metallized film in place of a plastic housing may provide one or more benefits including, for example, reduced cost, reduced volume, and/or reduced mass of finished product. After one or more portions of barrier layer 140 are disposed around the housing 120 and the cell stack 110, a sealing material (e.g., a polymer sealing strip) may be applied to open edges between the housing 120 and the barrier layer 140, and a portion of the barrier layer 140 may be thermally bonded to the sealing material, thereby creating a hermetically sealed housing 120 that is lighter and thinner than a housing formed entirely from metal.

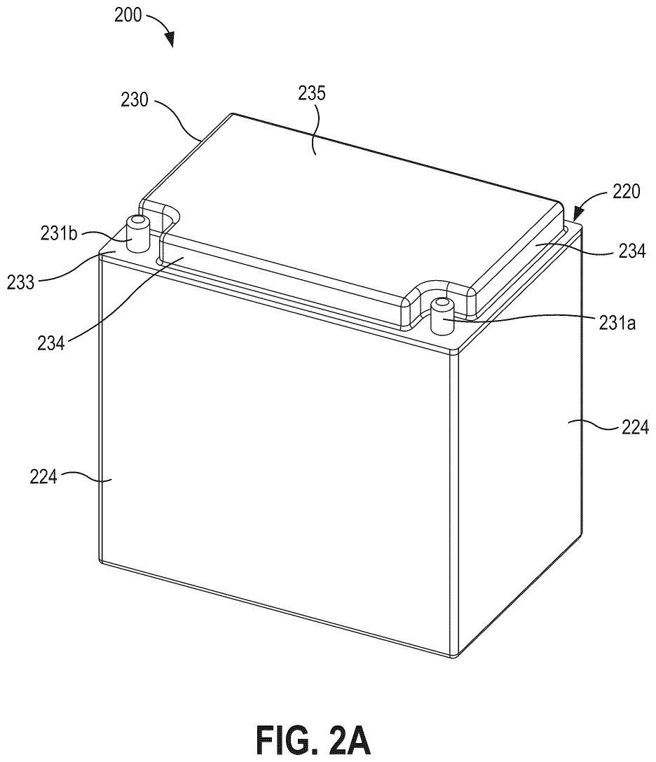

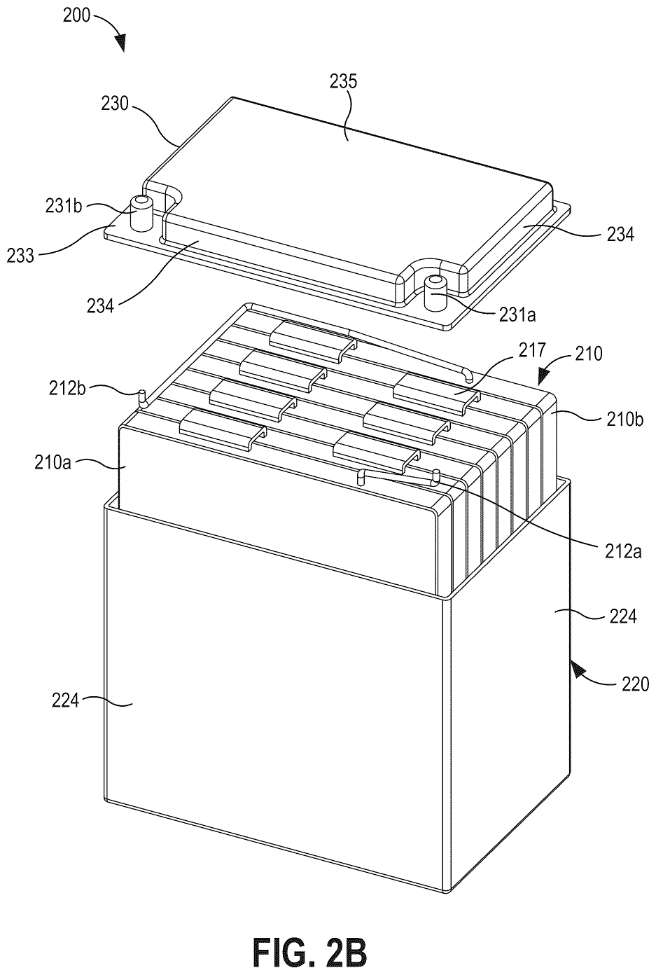

FIGS. 2A-2B show an assembly 200 including an electrochemical cell stack 210 disposed in an inner volume of a housing 220 without a barrier layer disposed thereon, according to an embodiment. The housing 220 may be a substantially rectangular shape including a bottom surface and four sidewalls 224 configured to be coupled to a cover or lid 230 (hereinafter, “the lid 230”). In some embodiments, the bottom surface and the four sidewalls 224 may be coupled together (e.g., via welding, mechanical fasteners, etc.) and define an opening through which the cell stack 210 may be disposed. In some embodiments, the bottom surface and the four sidewalls 224 may be monolithically formed (e.g., via molding, extrusion, casting, deep-drawing, etc.). The lid 230 may be configured to cover the opening and be fixed to the four sidewalls 224 to close the housing 220. In some embodiments, the lid 230 may be fixed to the four sidewalls 224 using any suitable method such as, for example, laser welding (e.g., hermetic welding), mechanical fasteners, snap fitting, adhesive, thermal bonding, chemical bonding, and/or a suitable combination thereof. While shown as a rectangular shape, the housing 220 may be any suitable shape configured to receive an electrochemical cell or cell stack 210 such as, for example, a cube, a cylinder, a polygonal prism, an oval cylinder, and all such embodiments are envisioned and should be considered to be within the scope of the present disclosure.

The lid 230 may include a first terminal 231a (e.g., a positive terminal) disposed on a first corner of the lid 230 and a second terminal 231b (e.g., a negative terminal) disposed on a second corner of the lid 230 adjacent to the first corner. In some embodiments, the lid 230 may include a raised portion 235. For example, the lid 230 may include a first flat portion 233 on which the first and second terminals 231a, 231b are disposed, a plurality of sidewalls 234 extending substantially orthogonal to the first flat portion 233, and a second flat portion connected to the plurality of sidewalls 234 and parallel to the first flat portion 233. The raised portion 235 may be configured to fit around one or more connectors 217 (e.g., tabs, busbars, clamps, etc.) extending from an end of the cell stack 210 toward the lid 230, as shown in FIG. 2B.

As shown, the electrochemical cells may be formed into one or more cell substacks 210a, 210b, each cell substack coupled to a connector 217. The cell substacks may be stacked together to form a cell stack 210. In some embodiments, the connectors 217 may be configured to connect the cell substacks in series and/or in parallel. As shown in FIG. 2B, the cell stack 210 may be disposed in the inner volume defined by the housing 220. The cell stack 210 may include a first electrical lead 212a (e.g., wire, cable, cord, busbar, rod, etc.) and a second electrical lead 212b (e.g., wire, cable, cord, busbar, rod, etc.). The first electrical lead 212a may be configured to electrically connect a first current collector (e.g., an anode current collector) of a first electrochemical cell or of each of the first current collectors in a first cell substack 210a to the first terminal 231a disposed on the lid 230. The second electrical lead 212b may be configured to electrically connect a second current collector (e.g., a cathode current collector) of a second electrochemical cell or each of the cathode current collectors in a second substack 210b to the second terminal 231b disposed on the lid 230.

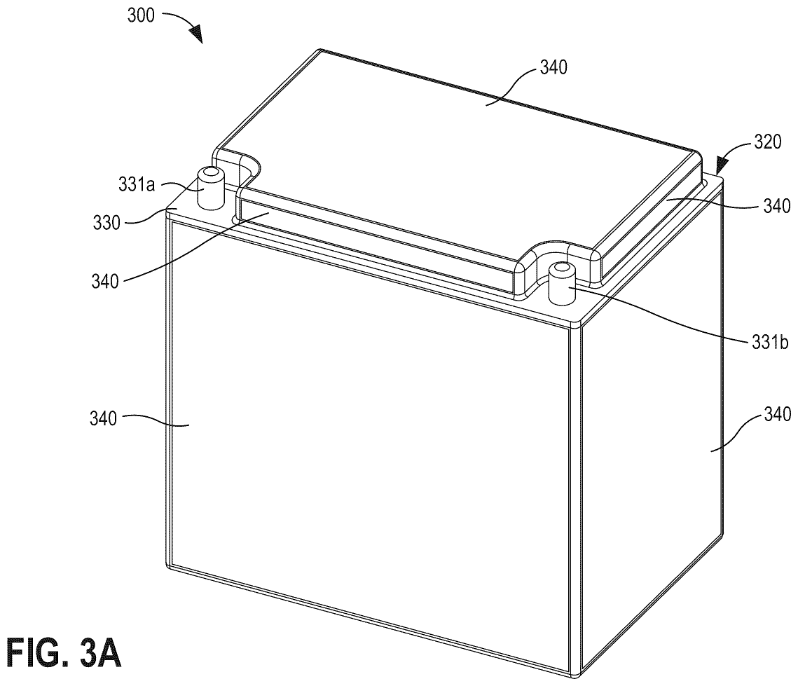

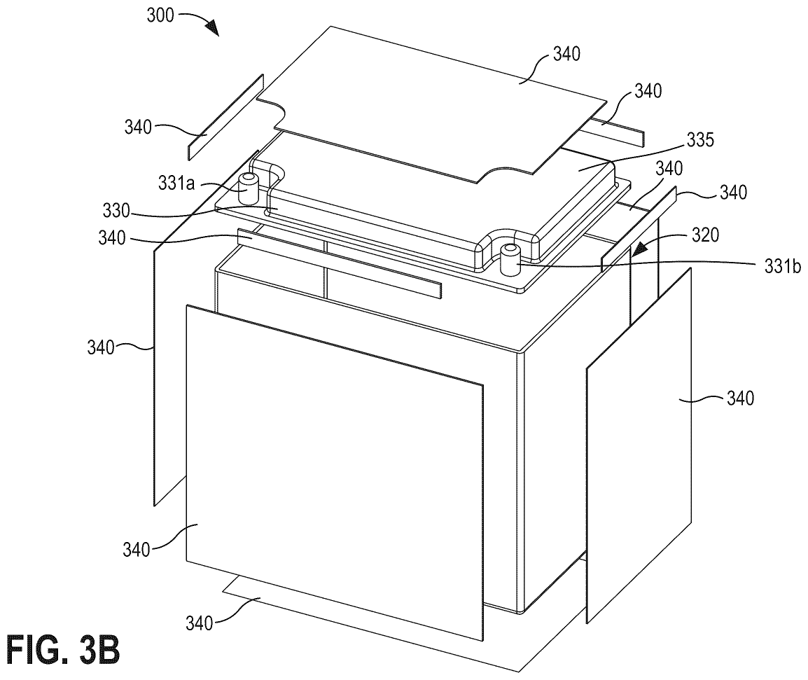

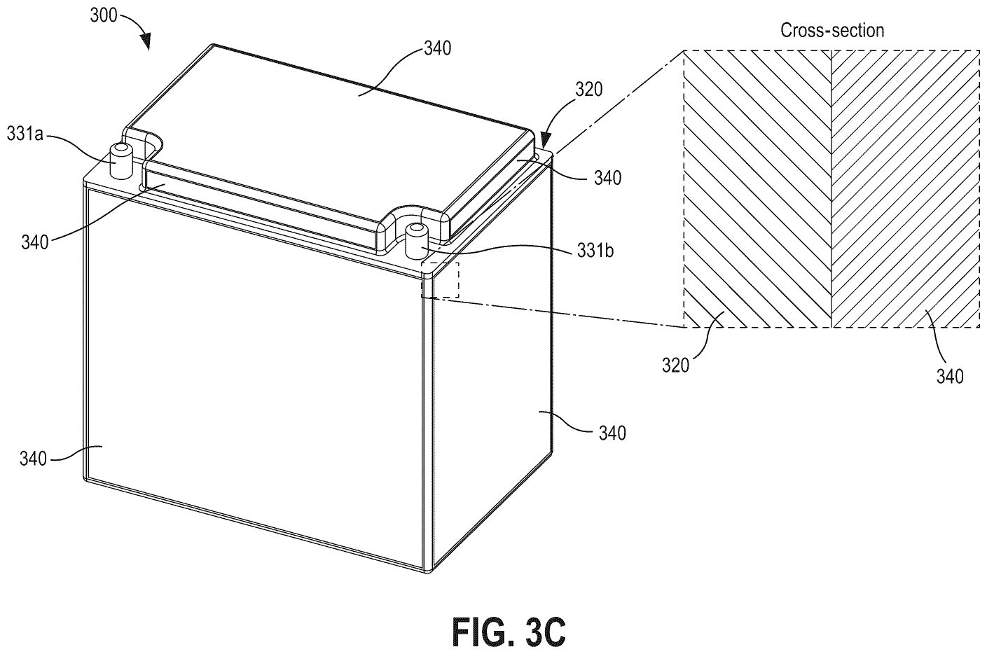

FIGS. 3A-3B shows an assembly 300 with a barrier layer 340 disposed on a portion of an outer surface of the housing 320, according to an embodiment. The housing 320 may include a bottom surface and four sidewalls configured to be coupled to a cover or lid 330 (hereinafter, “the lid 330”). The assembly 300 may be structurally and/or functionally similar to the assembly 100, 200, and therefore certain details of the assembly 100 are not described in further detail herein. As shown, one or more outer surfaces of the housing 320 may be configured to receive a respective portion of the barrier layer 340. For example, the bottom surface and the four sidewalls may each be coupled to a piece of barrier layer 340. The piece of barrier layer 340 may have dimensions corresponding to a respective surface of the housing 320 on which the barrier layer is disposed. For example, the barrier layer 340 may include five shapes (e.g., five rectangular shapes), each shape configured to be disposed on one of the side walls and the bottom surface. The lid 330 may include a raised portion, therefore, the barrier layer 340 may include portions configured to cover each sidewall (e.g., four sidewalls) of the lid 330 and a top surface 335 of the lid 330. In some embodiments, one or more edges and/or corners of the housing 320 may not be covered with the barrier layer 340.

FIG. 3C shows a cross-section view of an interface between a surface of the housing 320 and the barrier layer 340, according to an embodiment. As shown, the barrier layer 340 is configured to be in contact with an outer surface of the housing 320. In some embodiments, the barrier layer 340 may have a width smaller than a width of a wall of the housing 320 on which it is disposed.

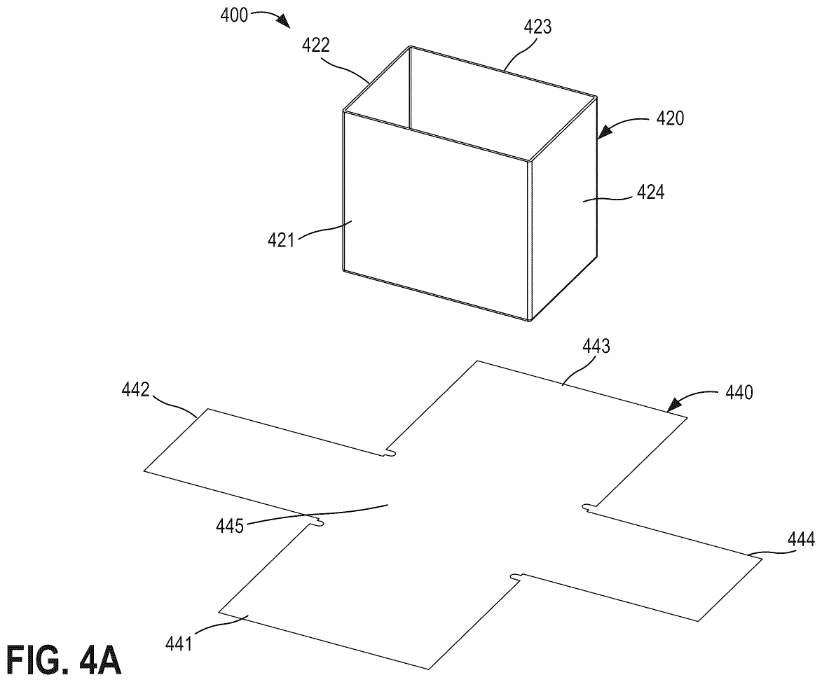

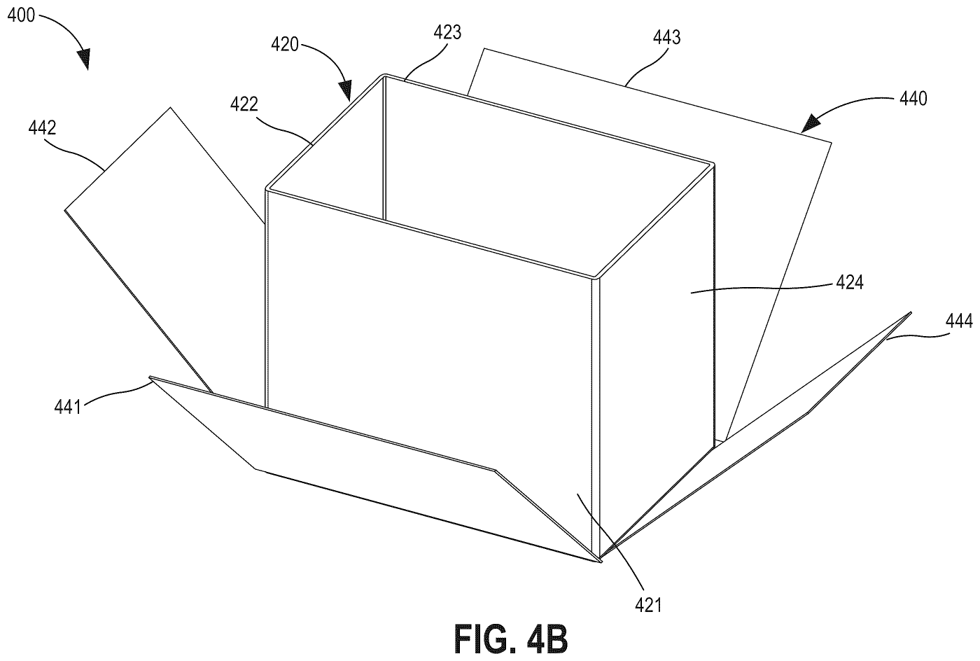

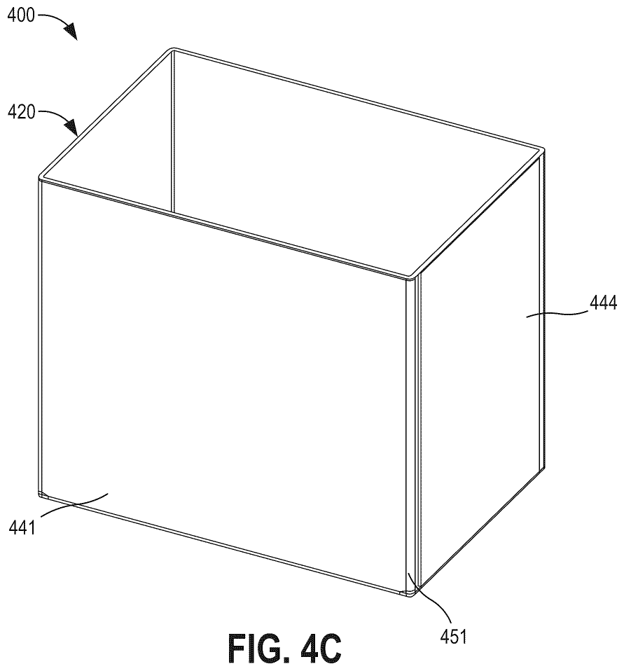

FIG. 4A-4C show a barrier layer 440 being wrapped around an outer surface of a housing 420 on five sides of the housing 420, according to an embodiment. As shown, the barrier layer 440 may form a sheet (e.g., a contour wrap) configured to be disposed on (e.g., wrap around) a plurality of sidewalls 421, 422, 423, 424 of the housing 420. For example, the barrier layer 440 may be formed into a sheet having a central region or base portion 445, and four extensions or portions 441, 442, 443, 444 extending outwards in different directions from the central region or base portion 445. For example, the barrier layer 440 may form a cross shape, or a “X” shape. The central region 445 may be configured to be disposed on a bottom surface (e.g., an outer surface of the bottom surface) of the housing 420, and each extension 441, 442, 443, 444 may be folded onto a respective sidewall (e.g., outer surface of the respective sidewall) of the housing 420 to be disposed thereon.

For example, the first extension 441 may fold upward onto the first sidewall 421, the second extension 442 may fold upward onto the second sidewall 422, the third extension 443 may fold up onto the third sidewall 423, and the fourth extension 444 may fold up onto the fourth sidewall 424. In some embodiments, one or more dimensions of each extension 441, 442, 443, 444 may correspond to one or more dimensions of a respective wall 421, 422, 423, 424 of the housing 420. In some embodiments, the sheet of the barrier layer 440 may be configured such that when the sheet is folded onto the sidewalls 421, 422, 423, 424 of the housing 420, the edges of the housing 420 are covered by the barrier layer 440. For example, edges of each of the extensions 441, 442, 443, 444 may be configured to fold over at least a portion of a respective edge of the housing 420. In this way, the barrier layer 440 may inhibit ingress and/or egress of moisture along the surfaces and edges of the housing 420. In some embodiments, the edges of the housing 420 may not be covered by the extensions 441, 442, 443, 444 of the barrier layer 440, and the edges of the housing 420 may be sealed separately. For example, the edges may be sealed by a sealant. In some embodiments, the edges of the housing 420 may not be additionally sealed.

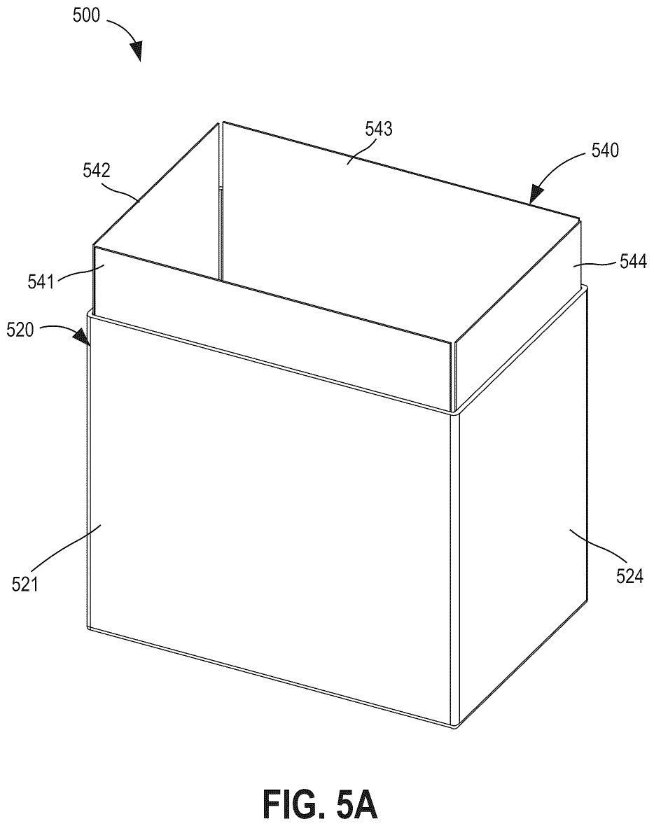

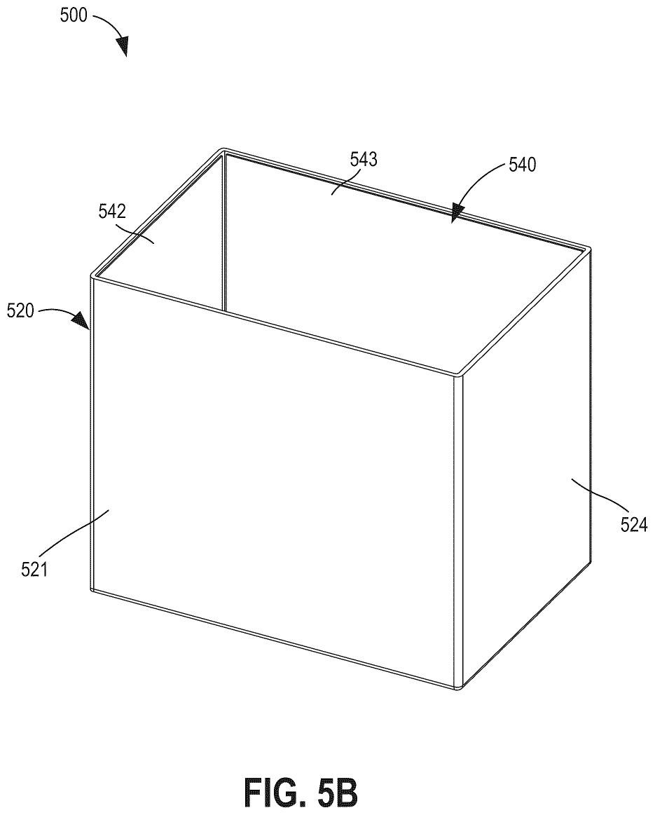

FIG. 5A-5B show a barrier layer 540 being disposed on at least a portion of an inner surface of a housing 520 on five sides of the housing 520, according to an embodiment. The barrier layer 540 may be substantially similar to the barrier layer 440 with the difference that the sheet of the barrier layer 540 is configured (e.g., sized and shaped) to be disposed inside the housing 520 (e.g., in an inner volume of the housing 420) and cover at least a portion of the inner surface of the walls of the housing 520. In some embodiments, a sheet of barrier layer 540 may be disposed on at least a portion of both an inner surface and an outer surface of the housing 520. In some embodiments, the sheet(s) of the barrier layer 540 may be disposed on (e.g., cover) up to 100% of a total surface of the housing 520, for example, disposed on faces as well as corners and edges of the walls of the housing 520.

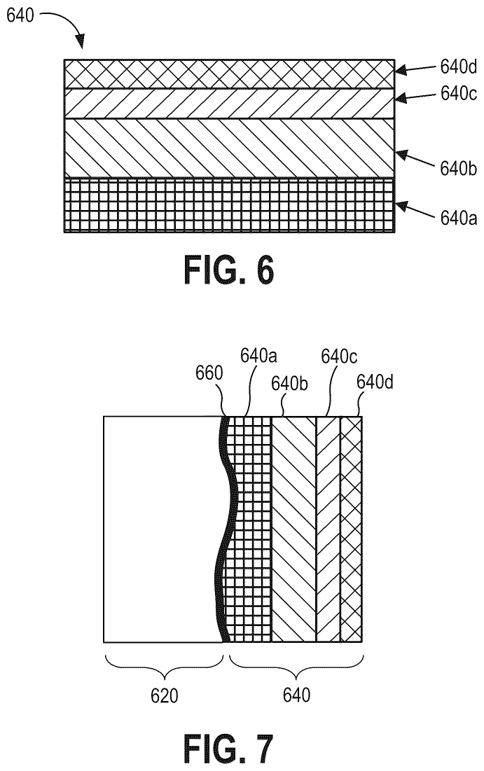

FIG. 6 illustrates a barrier layer 640 including a plurality of layers 640a, 640b, 640c, 640d, (collectively, “640a-640d), according to an embodiment. As shown, the barrier layer 640 may include a first layer 640a, a second layer 640b disposed on the first layer 640a, a third layer 640c disposed on the second layer 640b, and a fourth layer 640d disposed on the third layer 640c. In some embodiments, the barrier layer 640 may be structurally and/or functionally similar to the barrier layer 140, 340, 440, 540, and therefore, certain details of the barrier layer 640 are not described in further detail herein. In some embodiments, a width of the third layer 640c and the fourth layer 640d may be smaller than a width of the first layer 640a and the second layer 640b. As shown, the first layer 640a and the second layer 640b may have a first width, and the third layer 640c and the fourth layer 640d may have a second width smaller than the first width. In some embodiments, a thickness of the third layer 640c and/or the fourth layer 640d may be smaller than a thickness of the first layer 640a and/or the second layer 640b. In some embodiments, the first layer 640a and the second layer 640b may have a first thickness, and the third layer 640c and the fourth layer 640d may have a second thickness smaller than the first thickness. In some embodiments, the first layer 640a may include PP, the second layer 640b may include aluminum, the third layer 640c may include nylon, and the fourth layer 640d may include PET.

FIG. 7 is a schematic of the barrier layer 640 bonded to a surface of a portion of a housing 620 via a bond 660 (e.g., a thermal bond or chemical bond, etc.), according to an embodiment. As shown, a first surface of the first layer 640a (e.g., the layer including PP) may be bonded to a surface (inner or outer) of the housing 620, for example, via the bond 660. In some embodiments, the bond 660 may be a heat bond. For example, the housing 620 and the first layer 640a may be formed from the same material (e.g., PP) such that both the housing 620 and the first layer 640a have substantially the same melting or plastic temperature, thereby facilitating thermal bonding of the first layer 640a and thereby, the barrier layer 640 to the corresponding surface of the housing 620. In some embodiments, the bond 660 (e.g., heat bond) may fuse the surface of the housing 620 and the first layer 640a together. For example, after the heat bond, the surface of the housing 620 and the first layer 640a may be continuous with one another. Moreover, disposing the second layer 640b, which may include aluminum, between the first layer 640a and the third layer 640c, which may include nylon, may protect the second layer 640b from corrosion and damage.

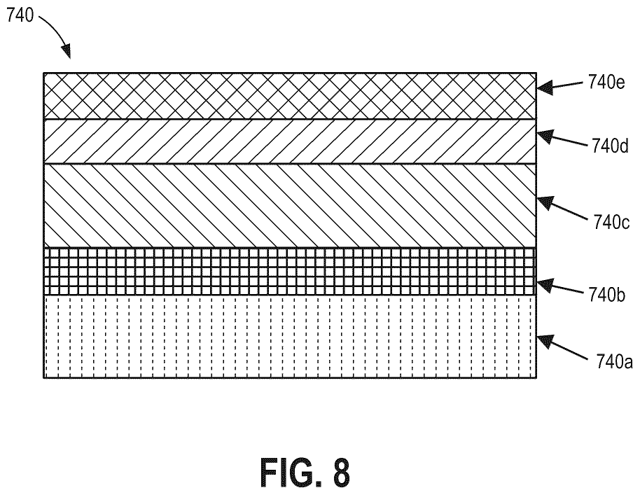

FIG. 8 is a schematic of a barrier layer 740 including a plurality of layers 740a, 740b, 740c, 740d, 740e (collectively, “740a-740e”), according to an embodiment. As shown, the barrier layer 740 includes a first layer 740a, a second layer 740b disposed on the first layer 740a, a third layer 740c disposed on the second layer 740b, a fourth layer 740d disposed on the third layer 740c, and a fifth layer 740e disposed on the fourth layer 750d. In some embodiments, the barrier layer 740 may be structurally and/or functionally similar to the barrier layer 140, 340, 440, 540, 640, and therefore, certain details of the barrier layer 740 are not described in further detail herein. In some embodiments, a width of the second layer 740b, the fourth layer 740d, and the fifth layer 740e may be smaller than a width of the first layer 740a and the third layer 740c. In some embodiments, the first layer 740a and the third layer 740c may have a first width and the second layer 740b, the fourth layer 740d, and the fifth layer 740e may have a second width smaller than the first width. In some embodiments, the first layer 740a may include LLDPE, the second layer 740b may include PE, the third layer 740c may include aluminum, the fourth layer 740c may include PE, and the fifth layer 740e may include PET. In some embodiments, the first layer 740a may be configured to be bonded to a surface (inner or outer) of a housing (e.g., any of housings 120, 220, 320, 420, 520, 620). In some embodiments, the first layer 740a may be heat bonded to the housing.

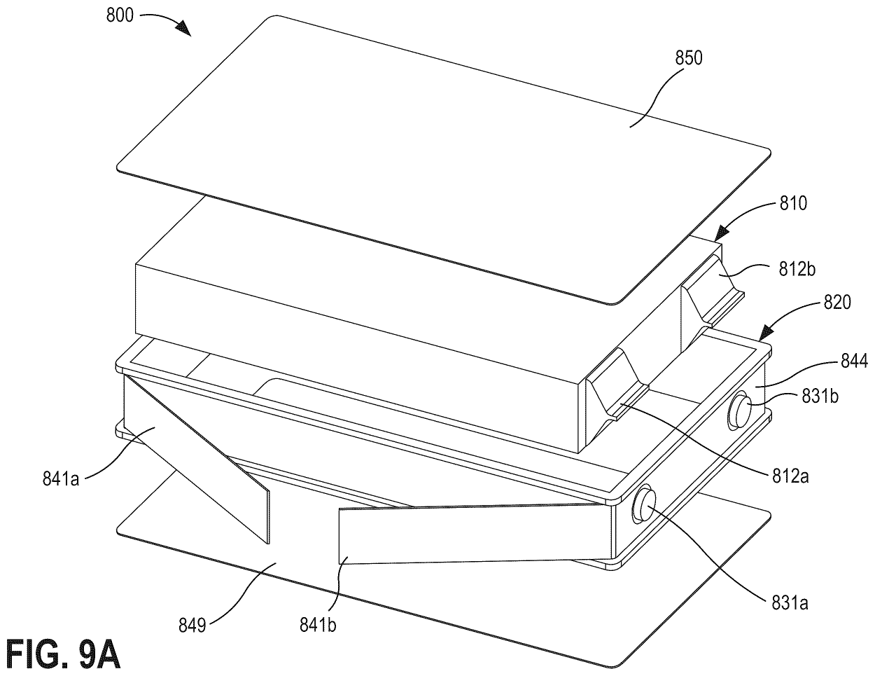

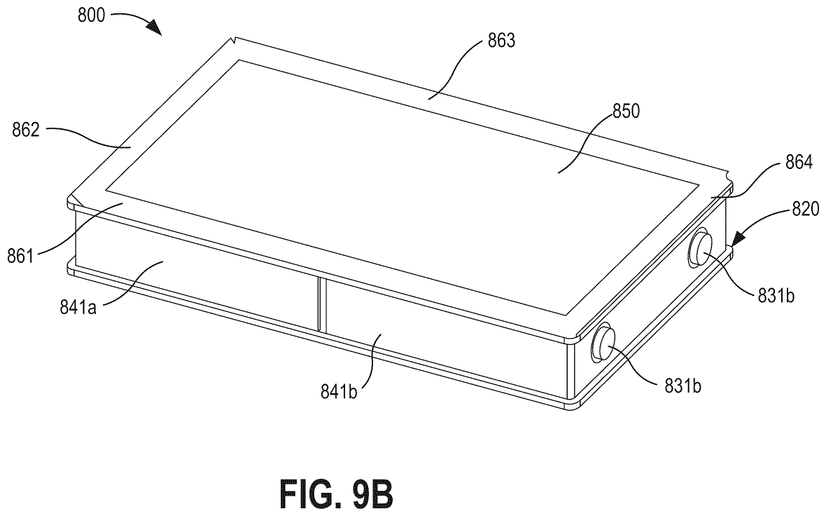

FIG. 9A is an exploded view of an assembly 800 including a cell stack 810 disposed in a housing 820 including one or more barrier layers 841a, 841b, 844, 849, 850 (collectively referred to as “barrier layer 840”) coupled to the housing 820, according to an embodiment. As shown, the cell stack 810 may include a first electrical lead 812a (e.g., wire, cable, cord, busbar, rod, etc.) and a second electrical lead 812b (e.g., wire, cable, cord, busbar, rod, etc.), and the housing 820 may include a first terminal 831a (e.g., positive terminal) and a second terminal 831b (e.g., negative terminal). In some embodiments, the first and second electrical leads 812a, 812b may be configured to align with and electrically couple to the first and second terminals 831a, 831b, respectively, when the cell stack 810 is disposed in the housing 820.

As shown, one or more sections of the housing 820 may be replaced entirely by the barrier layer 840. For example, a top surface and a bottom surface of the housing 820 may be replaced with barrier layers 850 and 849, respectively. Expanding further, in some embodiments, the housing 820 may have openings defined in one or more open side walls (e.g., top and bottom sides) of the housing 820, or one or more sidewalls of the housing 820 may be excluded such that when cell stack 810 is disposed in the housing 820, corresponding side of the cell stack 810 are exposed to the external environment or otherwise, accessible from the external environment. In such embodiments, portions or sheets of barrier layer 840, such as barrier layers 841a, 841b, 844, may be disposed on the sides of the housing 820 as well as directly on the top surface (e.g., barrier layer 850) and the bottom surface (e.g., barrier layer 849) of the cell stack 110 to inhibit moisture ingress or egress from the sides of the cell stack 810 that are proximate to the open sides of the housing 820.

In some embodiments, the housing 820 having two open sides may allow for easier and faster assembly and/or less material needed for the assembly. In some embodiments, the barrier layer 840 may be a metallized film as described herein. Using metallized film in place of a plastic housing may provide one or more benefits including, for example, reduced cost, reduced volume, and/or reduced mass of finished product.

As shown in FIG. 9B, after one or more portions of barrier layer 840 are disposed around the housing 820 and the cell stack 810, a sealing material 861, 862, 863, 864 (collectively referred to as “sealing material 860”) (e.g., a polymer sealing strip) may be applied to open edges between the housing 820 and the barrier layer 840. A portion of the barrier layer 840 may be thermally bonded to the sealing material 860, thereby creating a hermetically sealed housing 820 that is lighter and thinner than a housing formed entirely from metal.

For example, the sealing material 860 may be disposed at edges between barrier layer 850 and the housing 820 and/or the cell stack 810 so as to hermetically seal the housing 820. In some embodiments, a first sealing material 861 may be disposed along a first edge of the housing 820, a second sealing material 862 may be disposed along a second edge of the housing 820, a third sealing material 863 may be disposed along a third edge of the housing 820, and a fourth sealing material 864 may be disposed along a fourth edge of the housing 820. In some embodiments, portions of the first, second, third, and fourth sealing materials 861, 862, 863, 864 may overlap and/or be sealed (e.g., thermally bonded) to one another. For example, as shown, the first, second, third, and fourth sealing materials 861, 862, 863, 864 may be joined to one another at meeting points proximate to and/or overlapping with respective corners of the housing 820 and/or the cell stack 810.

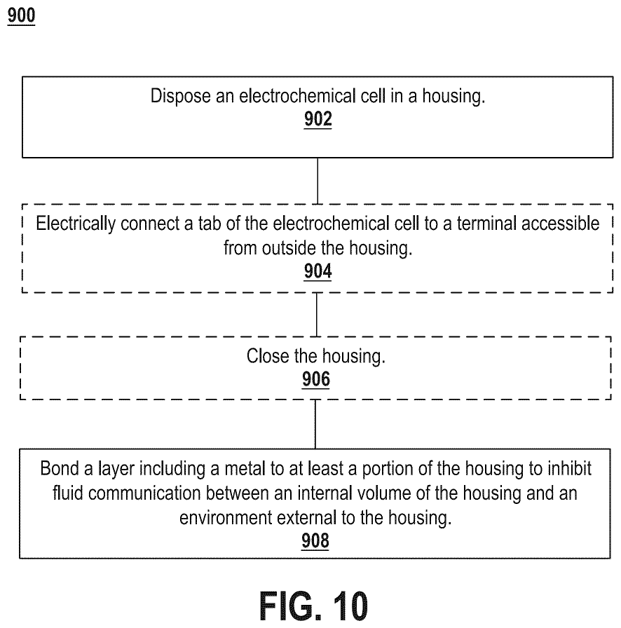

FIG. 10 is a flow chart of a method 900 for at least partially encasing an electrochemical cell in a housing with a barrier layer, according to an embodiment. While described with respect to the assembly 100 including the cell stack 110, the housing 120, and the barrier layer 140, the method 900 is equally applicable to any electrochemical cell assembly including any cell stack, housing, and/or barrier layer subassembly described herein. All such variants should be considered to be within the scope of this disclosure.

In some embodiments, method 900 includes disposing an electrochemical cell 110a in a housing 120, at 902. In some embodiments, a plurality of electrochemical cells (e.g., electrochemical cells 110a-110n) may be arranged to form a cell stack 110, and the cell stack 110 may be disposed in an inner volume defined by the housing 120. At 904, the method 900 may optionally include electrically connecting a tab (e.g., a terminal) of the electrochemical cell(s) to a terminal accessible from outside of the housing 120. For example, the cell stack 110 may include a plurality of substacks, each substack including a plurality of electrochemical cells arranged in a stack. In some embodiments, each substack may be coupled to a tab extending from a terminal end of the substack. In some embodiments, the tab of a first electrochemical cell and/or the tab of a first substack may be electrically connected to a first external terminal disposed on a lid of the housing 120. In some embodiments, the tab of a second electrochemical cell and/or the tab of the second substack may be electrically connected to a second external terminal disposed on the lid of the housing 120. In some embodiments, the first external terminal may be a positive terminal or a cathode terminal, and the second external terminal may be a negative terminal or an anode terminal. In some embodiments, the tabs may be connected to the external terminals via any suitable connection including, for example, a wire or a cable.

In some embodiments, the method 900 may optionally include closing the housing 120, at 906. In some embodiments, the closing the housing 120 may include coupling the lid to sidewalls of the housing 120 (e.g., four sidewalls for a square or rectangular housing) to cover an opening defined by the sidewalls. In some embodiments, the lid may be sealed (e.g., hermetically sealed) to the four sidewalls such that an inner volume of the housing 120 is sealed (e.g., hermetically sealed) from an external environment. In some embodiments, the lid may be welded to the sidewalls of the housing 120. In some embodiments, the lid may be coupled to the sidewalls via mechanical fasteners, and one or more portions of the mechanical fasteners may be welded to seal the housing 120.

At 908, the method 900 includes bonding a barrier layer 140 including a metal to at least a portion of the housing 120 to inhibit fluid communication between the internal volume of the housing 120 and an environment external to the housing 120. In some embodiments, when the barrier layer 140 is bonded to the portion of the housing 120, the inner volume of the housing 120 may be substantially fluidically isolated from the external environment. In some embodiments, the barrier layer 140 may be bonded to an outer surface of the housing 120. In some embodiments, the housing may be substantially rectangular, and at least a portion of the barrier layer 140 may be configured to be bonded to each flat outer surface of the housing 120. In some embodiments, the barrier layer 140 may be configured to be bonded to each flat inner surface of the housing 120. In some embodiments, the barrier layer 140 may be configured to be bonded to both the flat inner surface and the flat outer surface of the housing 120. In some embodiments, the barrier layer 140 may be bonded over at least 80% of the outer surface and/or the inner surface of the housing 120. In some embodiments, the barrier layer 140 may include a plurality of portions or separate pieces, each portion or piece configured to be disposed on and/or bonded to a respective flat surface of the housing 120. In some embodiments, the plurality of portions may be coupled together such that the barrier layer 140 forms a sheet, and the sheet may be wrapped around the outer surface of the housing 120. In some embodiments, the sheet may be disposed on the inner surface of the housing 120 in addition to or alternatively to the outer surface. In some embodiments, a sealing material may be disposed over one or more openings defined by the barrier layer 140. For example, the sealing material may be disposed over edges of the housing 120 in which no barrier layer 140 is bonded. In some embodiments, the barrier layer 140 may replace one or more surfaces of the housing 120.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10% Where a range of values is provided, it is understood that each intervening value, to the tenth of the unit of the lower limit unless the context clearly dictates otherwise, between the upper and lower limit of that range and any other stated or intervening value in that stated range is encompassed within the disclosure That the upper and lower limits of these smaller ranges can independently be included in the smaller ranges is also encompassed within the disclosure, subject to any specifically excluded limit in the stated range Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.c., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B), in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e, the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e, “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A), in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An assembly, comprising:
a housing defining an internal volume;
an electrochemical cell disposed in the internal volume; and
a barrier layer disposed on at least a portion of the housing, the barrier layer including a metal and configured to inhibit fluid communication between the internal volume of the housing and an external environment.

2. The assembly of claim 1, wherein the barrier layer includes a plurality of layers, at least one of the plurality of layers including the metal.

3. The assembly of claim 2, wherein the plurality of layers include:
a first layer disposed on a surface of the housing, the first layer formed of a first material; and
a second layer disposed on the first layer, the second layer formed from a second material including the metal.

4. The assembly of claim 3, wherein:
the housing is also formed of the first material, and
the first layer of the barrier layer is thermally bonded to the surface of the housing.

5. The assembly of claim 3, wherein the plurality of layers further includes:
a third layer disposed on the second layer, the third layer formed of a third material different from the first material and the second material; and
a fourth layer disposed on the third layer, the fourth layer formed of a fourth material different from the first material, the second material, and the third material.

6. The assembly of claim 5, wherein:
the first material includes polypropylene,
the third material includes nylon, and
the fourth material includes polyethylene terephthalate (PET).

7. The assembly of claim 1, wherein the barrier layer is disposed on at least a portion of an outer surface or an inner surface of the housing.

8. The assembly of claim 1, wherein the barrier layer is bonded to the housing via at least one of a thermal bond, a pressure sensitive adhesive, or over-molding.

9. The assembly of claim 1, wherein the barrier layer has a thickness of less than about 0.01 mm to about 20 mm.

10. The assembly of claim 1, wherein the barrier layer is disposed on at least 80% of a surface area of the housing.

11. The assembly of claim 1, wherein:
the housing defines one or more openings through which corresponding outer surfaces the electrochemical cell are exposed to the external environment, and
the barrier layer is also disposed on at least portions of the outer surfaces of the electrochemical cell, which are exposed to the external environment.

12. An assembly, comprising:
a housing having an internal volume, the housing including a first polymer material;
a cell stack disposed in the internal volume, the cell stack including a plurality of electrochemical cells; and
a barrier layer assembly disposed on at least a portion of the housing, the barrier layer assembly including:
a first layer including a second polymer material, the first layer disposed on the housing;
a second layer disposed on the first layer, the second layer including a metal material; and
a third layer disposed on the second layer, the third layer including a third polymer material,
the barrier layer assembly configured to inhibit fluid communication between the internal volume of the housing and a region outside the housing.

13. The assembly of claim 12, wherein the first layer is thermally bonded to the housing.

14. The assembly of claim 12, wherein the first polymer material of the housing and the second polymer material of the first layer each include at least one of polyethylene (PE), polypropylene (PP), polystyrene, polyethylene terephthalate (PET), high density polyethylene (HDPE), low density polyethylene (LDPE), linear low density polyethylene (LLPDE), polyvinyl chloride (PVC), polyether ether ketone (PEEK), polybutylene terephthalate (PBT), polyvinylidene fluoride (PVDF), polycarbonate, polyethylene naphthalate (PEN), polysulfone, nylon, polyphenylene sulfide (PPS), polyimide (PI), polyamide-imide (PAI), or polytetrafluoroethylene (PTFE).

15. The assembly of claim 14, wherein the first polymer material and the second polymer each include at least one of polypropylene (PP), polyethylene terephthalate (PET), polyethylene (PE), or nylon.

16. The assembly of claim 12, wherein the metal includes at least one of aluminum, steel, copper, lead, nickel, tin, or titanium.

17. The assembly of claim 12, wherein the first layer and the third layer of the barrier layer assembly each include portions extending beyond a length or width of the second layer, the extended portion of the first layer coupled to the extended portion of the third layer to seal the second layer therebetween.

18. The assembly of claim 12, where the housing defines an opening on at least one sidewall thereof to expose a surface of the cell stack, at least a portion of the barrier layer assembly coupled to the exposed surface of the cell stack through the opening.

19. The assembly of claim 18, further comprising:
a sealing material disposed at an interface between the barrier layer assembly and at least one of the housing or the cell stack to hermetically seal the housing.

20. The assembly of claim 19, wherein the sealing material includes at a fourth polymer material.

21. A method, comprising:
disposing an electrochemical cell in an inner volume of a housing;
bonding a barrier layer to at least a portion of the housing, the barrier layer including at least a metal material and a polymer material disposed on the metal material, the barrier layer configured to inhibit fluid communication between the inner volume of the housing and a region external to the housing.

22. The method of claim 21, wherein the electrochemical cell includes a first electrode, a second electrode, a separator interposed between the first electrode and the second electrode, and a tab extending from at least one of the first electrode or the second electrode, the method further comprising:
electrically coupling the tab to a terminal disposed in the housing; and
electrically coupling a device to the terminal.

23. The method of claim 21, further comprising:
disposing a lid on an opening defined in the housing to enclose the electrochemical cell in the housing; and
disposing one or more sealing materials on an exposed edge of the housing to hermetically seal the electrochemical cell in the housing.
